(19) United States
(12) Patent Application Publication
(10) Pub. No.: US 2016/0095412 A1
(43) Pub. Date: Apr. 7, 2016

(54) LIGHT CURING APPARATUS FOR NAIL PAINTING

(71) Applicant: PRIOR COMPANY LIMITED, TAIPEI (TW)

(72) Inventor: ERIC JIH, NEW TAIPEI CITY (TW)

(21) Appl. No.: 14/506,795

(22) Filed: Oct. 6, 2014

(51) Int. Cl. A45D 29/20; B05C 9/14

(52) U.S. Cl. CPC A45D 29/20; B05C 9/14; A45D 2200/205

(57) ABSTRACT

A light curing apparatus for nail painting includes an upper seat structure and a lower seat structure. The upper seat structure includes a base and a casing mounted on the base. The base includes a lamp module for emitting ultraviolet light and a control unit for controlling the lamp module. The base further includes a shaft extended downwardly from the base, and the lower seat structure includes a shaft seat disposed at a position corresponsive to the shaft. The shaft is pivotally coupled to the shaft seat, so that the upper seat structure and the lower seat structure are pivotally coupled to each other, and the upper seat structure can be pivoted with respect to the lower seat structure to rotate the lamp module out for use.

### FIELD OF THE INVENTION

The present invention relates to an artistic nail polish curing apparatus, in particular to a pivot structure installed between internal components of a light curing apparatus for nail painting.

### BACKGROUND OF THE INVENTION

Modern women love to paint their nails to enhance appearance and pursue fashion, wherein nail painting is to paint nail polish onto the nails to form decorative patterns. After painting the nail polish, it is necessary to cure the nail polish to complete the nail painting process, and a curing apparatus is generally used for this purpose.

A compact and portable light curing apparatus disclosed in R.O.C. Pat. No. M472150 comprises a base having a space provided for a user to extend a finger therein, and an upper cover of a lamp holder combined with the top of the space, so that ultraviolet light may be irradiated towards the space, so as to achieve the effect of curing the nail polish painted on the user's nail. When a user wants to cure the artistic nail polish painted on the user's toe which is thicker and bigger than the user's finger, it will be difficult to extend the user's toe into the space of the light curing apparatus. Therefore, the conventional apparatus generally comes with an upper cover of the lamp holder that is detachable from the base, so that the upper cover of the lamp holder can be lifted to the outer side of the base to allow the ultraviolet light to be projected directly onto the user's toe. Specifically, the top of the base has two fixing pins, and the bottom of the upper cover of the lamp holder has two corresponding plug holes, so that after the upper cover of the lamp holder is detached and turned over, the two pins are plugged into and combined with the two plug holes respectively to complete the assembling procedure.

However, the aforementioned assembling procedure requires users to detach the lamp holder from the base completely before the assembling process can take place. The procedure is complicated, time-consuming and laborious. In addition, the detached upper cover of the lamp holder may be lost or missing easily, and the apparatus cannot be used when the upper cover of the lamp holder is lost or missing.

### SUMMARY OF THE INVENTION

Therefore, it is a primary objective of the present invention to provide a light curing apparatus for nail painting, and the light curing apparatus includes an upper seat structure that can be pivoted with respect to a lower seat structure to rotate a lamp module out, so as to facilitate the process of curing an artistic nail painting pattern painted on a user's nail.

To achieve the aforementioned objectives, the present invention provides a light curing apparatus for nail painting, comprising: an upper seat structure and a lower seat structure, characterized in that the upper seat structure includes a base and a casing mounted onto the base, and the base includes a lamp module for irradiating ultraviolet light, a control unit for controlling the lamp module, and a shaft extended downwardly from the base; and the lower seat structure includes a recession corresponsive to a position of the lamp module, and a shaft seat corresponsive to a position of the shaft, and the shaft is pivotally coupled to the shaft seat, such that the upper seat structure can be pivoted with respect to the lower seat structure.

Wherein, the upper seat structure includes a middle sea disposed between the base and the casing, and the base and the casing are fixed to the middle seat; and the control unit includes a capacitive touch circuit board, a conducting element and a power socket, and the power socket is electrically coupled to the touch circuit board, and an end of the conducting element is coupled to the touch circuit board, and the other end of the conducting element is passed through the middle seat and coupled to the casing, and a touch control area is defined at a position on the casing corresponsive to the conducting element; and the lamp module includes a plurality of light emitting diodes electrically coupled to the touch circuit board that can be controlled through the touch control area.

Further, the touch circuit board includes a light emitting element that can be controlled through the touch control area, and the casing is translucent, so that lights of the light emitting element can pass out from the casing.

Preferably, the shaft seat includes a fixing element installed at a bottom end of the shaft seat, and the fixing element is coupled to the shaft and pressed against the shaft seat.

Further, the lower seat structure includes a positioning pillar disposed in a neighborhood of the shaft seat, and a lug extended separately from both sides of the fixing element, and each lug includes a positioning portion that can be coupled and positioned with the positioning pillar.

### BRIEF DESCRIPTION OF THE DRAWINGS

FIG. 1 is a perspective view of the present invention;

FIG. 2 is an exploded view of the present invention;

FIG. 3 is a cross-sectional view of the present invention; and

FIGS. 4 and 5 are schematic views showing a rotating movement of the present invention.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

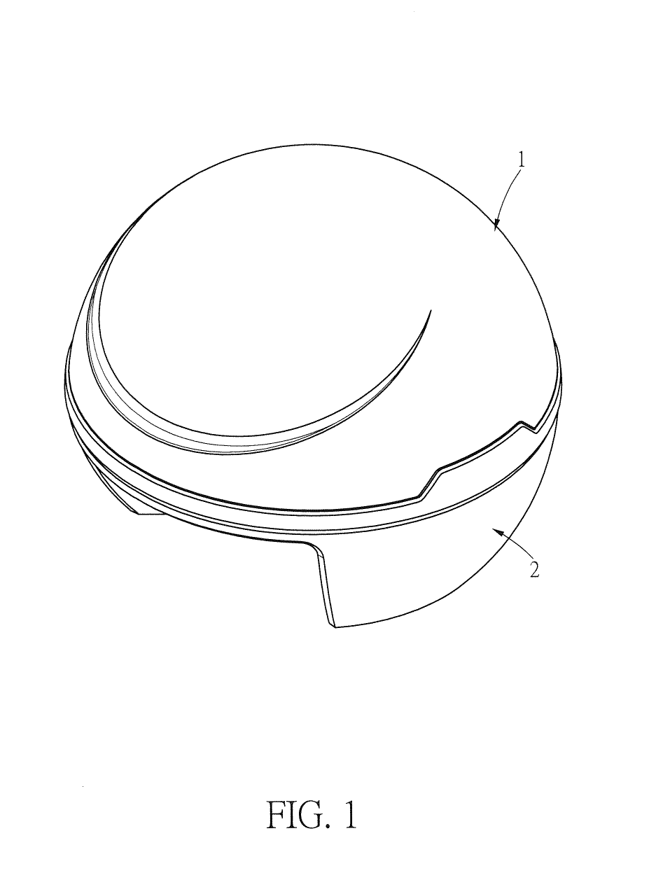

With reference to FIG. 1 for a light curing apparatus for nail painting in accordance with the present invention, the light curing apparatus comprises an upper seat structure 1 and a lower seat structure 2, wherein the upper seat structure 1 includes a lamp module for irradiating ultraviolet light, and the upper seat structure 1 and the lower seat structure 2 are pivotally coupled to each other, so that the upper seat structure 1 may be pivoted with respect to the lower seat structure 2. Since the position where the two are pivotally coupled is not the center position, therefore the upper seat structure 1 can be rotated out from the lower seat structure 2 in order to turn the lamp module out.

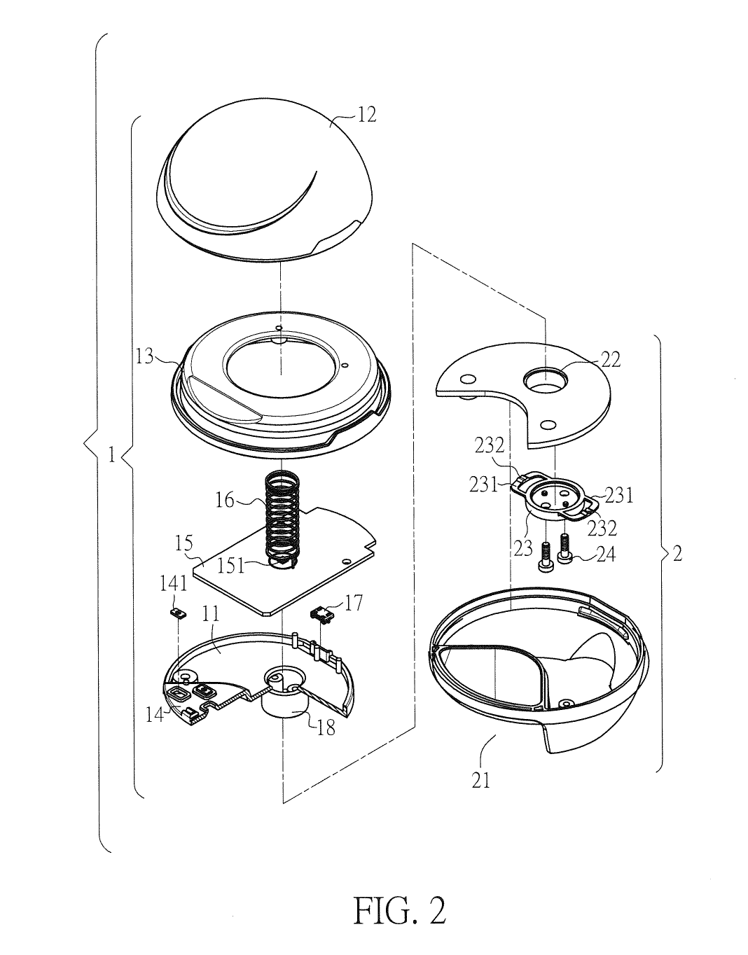

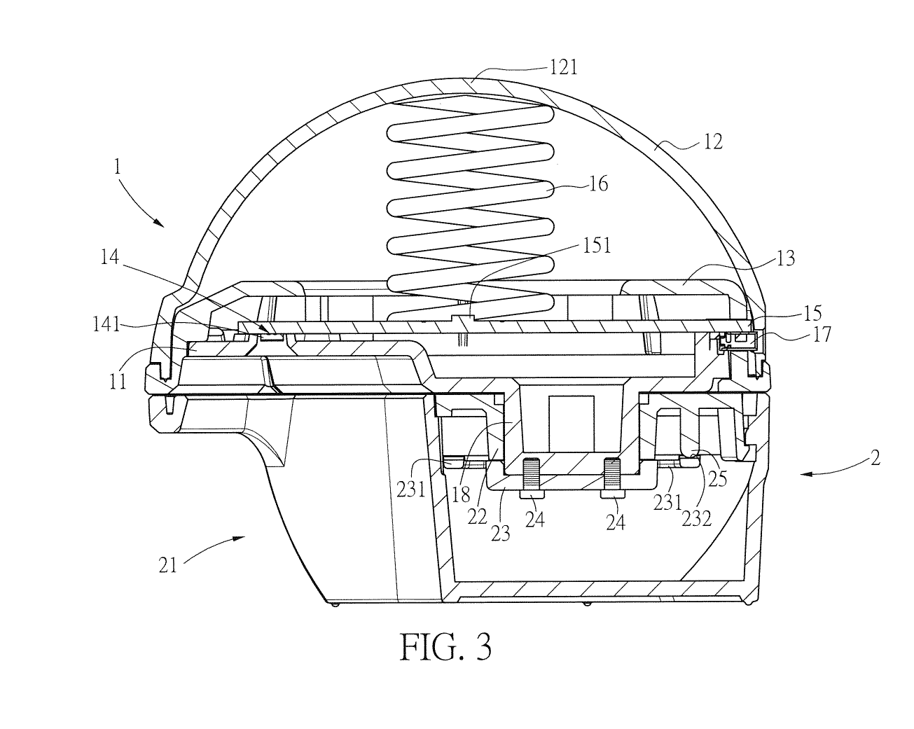

In FIGS. 2 and 3, the upper seat structure 1 includes a base 11 and a casing 12 mounted onto the base 11. In this preferred embodiment, a ring-shaped middle seat 13 is disposed between the base 11 and the casing 12, and the base 11 and the casing 12 are fixed to the middle seat 13. The base 11 includes a lamp module 14 for emitting ultraviolet light, and a control unit for controlling the lamp module 14. The control unit includes a capacitive touch circuit board 15, a conducting element 16 and a power socket 17, wherein the touch circuit board 15 is installed at the base 11, and power is supplied to the touch circuit board 15 through a power socket 17 electrically coupled to the touch circuit board 15. The lamp module 14 includes a plurality of light emitting diodes 141 capable of emitting ultraviolet light, and the light emitting diodes 141 are electrically coupled to the touch circuit board 15. The conducting element 16 is in a spring-like shape having an end coupled to the touch circuit board 15 and the other end passed through the middle seat 13 and coupled to the casing 12, and a touch control area 121 is defined at a position on the casing 12 corresponsive to the conducting element 16. A user may touch the touch control area 121 by a hand, such that the static charges in a human body can be transmitted to the touch circuit board 15 through the conducting element 16 to turn on the lamp module 14 to emit ultraviolet light. In addition, the touch circuit board 15 further includes a light emitting element 151, wherein the light emitting element 151 is controlled by the touch control area 121 and turned on to emit light. On the other hand, the casing 12 may be made of a translucent material, so that the light emitted from the light emitting element 151 can be passed through the casing 12 to the outside, so as to achieve the effect of prompting the ON status of the light curing apparatus of the present invention.

A shaft 18 in the shape of a pillar is extended downwardly from a position of the base 11 in the neighborhood of the lamp module 14 and such position is not a center position, and the shaft 18 serves as an axis for pivoting the upper seat structure 1 with respect to the lower seat structure 2. On the other hand, the lower seat structure 2 has a recession 21 concavely formed on a side of the lower seat structure 2 and disposed at a position corresponsive to the lamp module 14, and the recession 21 is provided for a user to extend a finger therein, so that the nail polish painted on the user's nails receives the ultraviolet light emitted from the lamp module 14 to achieve the curing effect. The lower seat structure 2 has a shaft seat 22 disposed at the rear of the recession 21 and corresponsive to the shaft 18, wherein the shaft seat 22 is a tubular plug hole provided for plugging the shaft 18, and a fixing element 23 is installed at a bottom end of the shaft seat 22, and a screw 24 is passed through the fixing element 23 and secured to the shaft 18. Therefore, the fixing element 23 and the shaft 18 are fixed as a whole and rotatable synchronously with the shaft 18, wherein the fixing element 23 has an external diameter equal to or greater than the shaft seat 22 for abutting the shaft seat 22, so that the upper seat structure 1 can be combined with the lower seat structure 2 by the shaft 18 and the fixing element 23. Although the shaft 18 is secured by the fixing element 23 and cannot move upwardly or downwardly, the shaft 18 can rotate freely in the shaft seat 22, so that the upper seat structure 1 can be rotated out from the lower seat structure 2 by using the shaft 18 as the axis of rotation.

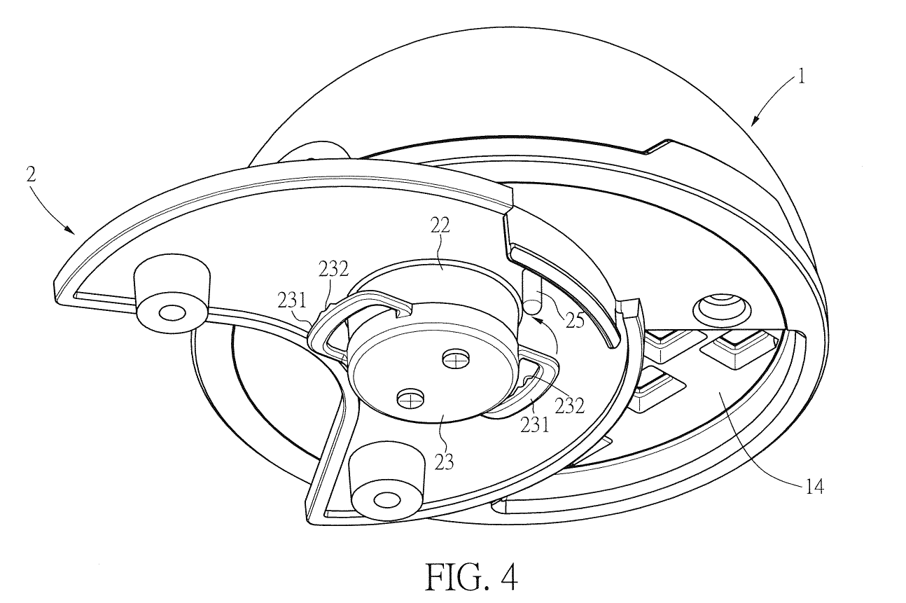

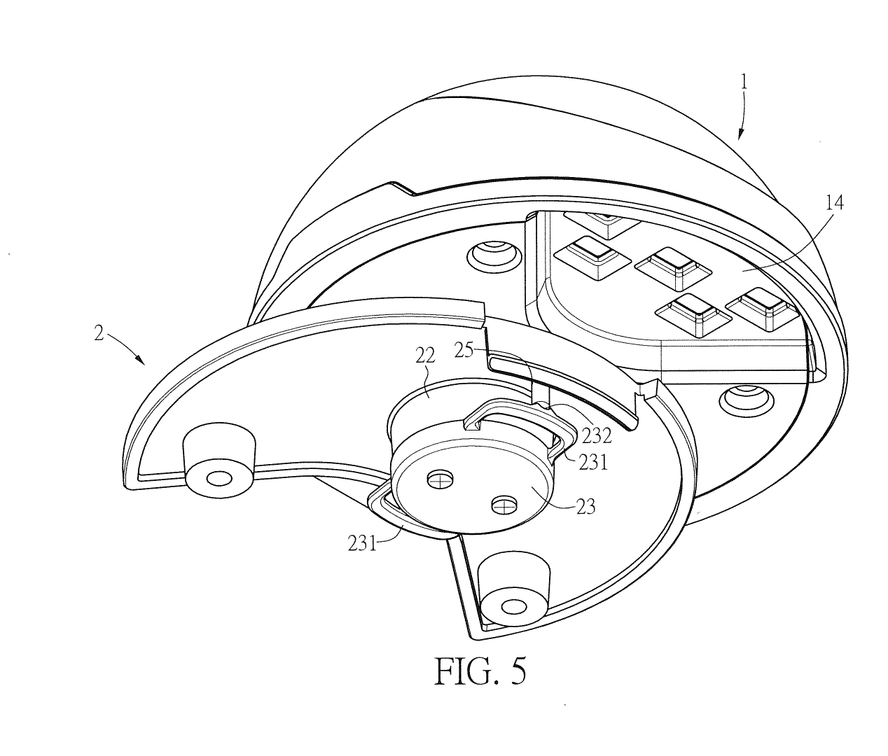

As described above, the upper seat structure 1 is pivoted, so that the lamp module 14 as shown in FIGS. 4 and 5 can be rotated out from the lower seat structure 2, and a user's fingers or toes can receive the ultraviolet light of the lamp module 14 conveniently from the outside of the lower seat structure 2 without the need of extending the fingers or toes into the recession.

In addition, a position function between the upper seat structure 1 and the lower seat structure 2 is provided, so that the structures 1, 2 can be fixed with each other after being rotated to a predetermined pivoting angle. In FIGS. 4 and 5, the lower seat structure 2 has a positioning pillar 25 disposed in the neighborhood of the shaft seat 22, and both sides of the fixing element 23 have a lug 231 separately, and each lug 231 includes a positioning portion 232, wherein the positioning portion 232 is in form of a groove. In this preferred embodiment, the two lugs 231 are separated with each other with an angle of 180 degrees, so that when the upper seat structure 1 is pivoted to an angle of 0 degree and an angle of 180 degrees with respect to the lower seat structure 2, the fixing element 23 is latched to the positioning pillar 25 by using a groove of one of the lugs 231, so as to achieve the effect of positioning the upper seat structure 1 and the lower seat structure 2.

In summation of the description above, the advantage of the present invention resides on that the upper seat structure of the lamp module can be rotated out from the lower seat structure by a pivoting structure to provide a convenient application. With the structure of the present invention, users simply need to turn the upper seat structure to rotate the lamp module out without being detached from the lower seat structure. Therefore, the operation of the present invention is very simple, easy and convenient.

1. A light curing apparatus for nail painting, comprising an upper seat structure and a lower seat structure, characterized in that:
the upper seat structure includes a base and a casing mounted onto the base, and the base includes a lamp module for irradiating ultraviolet light, a control unit for controlling the lamp module, and a shaft extended downwardly from the base; and
the lower seat structure includes a recession corresponsive to a position of the lamp module, and a shaft seat corresponsive to a position of the shaft, and the shaft is pivotally coupled to the shaft seat, such that the upper seat structure can be pivoted with respect to the lower seat structure.

2. The light curing apparatus for nail painting according to claim 1, wherein the upper seat structure includes a middle sea disposed between the base and the casing, and the base and the casing are fixed to the middle seat; and the control unit includes a capacitive touch circuit board, a conducting element and a power socket, and the power socket is electrically coupled to the touch circuit board, and an end of the conducting element is coupled to the touch circuit board, and the other end of the conducting element is passed through the middle seat and coupled to the casing, and a touch control area is defined at a position on the casing corresponsive to the conducting element; and the lamp module includes a plurality of light emitting diodes electrically coupled to the touch circuit board that can be controlled through the touch control area.

3. The light curing apparatus for nail painting according to claim 2, wherein the touch circuit board includes a light emitting element that can be controlled through the touch control area, and the casing is translucent, so that lights of the light emitting element can pass out from the casing.

4. The light curing apparatus for nail painting according to claim 1, wherein the shaft seat includes a fixing element installed at a bottom end of the shaft seat, and the fixing element is coupled to the shaft and pressed against the shaft seat.

5. The light curing apparatus for nail painting according to claim 4, wherein the lower seat structure includes a positioning pillar disposed in a neighborhood of the shaft seat, and a lug extended separately from both sides of the fixing element, and each lug includes a positioning portion that can be coupled and positioned with the positioning pillar.
